(19) United States
(12) Patent Application Publication
(10) Pub. No.: US 2018/0307751 A1
(43) Pub. Date: Oct. 25, 2018

(54) Musical Taste Profile

(71) Applicant: Microsoft Technology Licensing, LLC, Redmond, WA (US)

(72) Inventors: Melissa Nicole LIM, Paris (FR); Eric Long HSIA, Seattle, WA (US); Erika Catherine BAUER, Seattle, WA (US); Matthew MANG, Seattle, WA (US); Paul NOGUES, Clamart (FR); Pierre Serge Vincent LEROY, Cergy (FR); Mathias WENDLINGER, Paris (FR); Aaron James MONSON, Issaquah, WA (US); Colin Randall MOLL, Bothell, WA (US); Claudio Fernando GUGLIERI LILLO, Redmond, WA (US)

(73) Assignee: Microsoft Technology Licensing, LLC, Redmond, WA (US)

(21) Appl. No.: 15/630,111

(22) Filed: Jun. 22, 2017

Related U.S. Application Data
(60) Provisional application No. 62/488,274, filed on Apr. 21, 2017.

(51) Int. Cl. G06F 17/30; G06Q 30/06; H04L 29/08

(52) U.S. Cl. CPC G06F 17/30752; G06F 17/30035; G06F 17/30743; G10H 2240/131; H04L 67/22; G10H 2240/105; G06Q 30/0631

(57) ABSTRACT

Described herein is a system for recommending music using a music taste profile. The music taste profile includes information about musical taste of a particular user that can be used to provide music recommendation(s) targeted to that particular user. The system includes a recommendation component that makes a music recommendation(s) based on the music taste profile. The recommendation component can utilize an algorithm to make the music recommendation. With consent of the user, a music taste profile modification component can modify the music taste profile based on an inference from information regarding a music-related interest of the user received from a source (e.g., information obtained about a web browsing search history of the user, signal(s) provided by a digital assistant regarding information requested by the user and/or from a home automation device).

### RELATED APPLICATION

This application claims priority to U.S. Provisional Application No. 62/488,274, filed Apr. 21, 2017, entitled “Musical Taste Profile”, the disclosure of which is hereby incorporated by reference herein in its entirety.

### BACKGROUND

The amount of music available digitally can be daunting to even a sophisticated music enthusiast. For a casual user, identifying unfamiliar music that the user would like can be an overwhelming and intimidating experience.

### SUMMARY

Described herein is a system for recommending music using a music taste profile, comprising a computer including a processor and a memory. The memory includes a recommendation component configured to make a music recommendation to a user based on a music taste profile associated with the user, the recommendation component utilizing an algorithm to make the music recommendation. The memory further includes a music taste profile modification component configured to modify the music taste profile based on an inference from information regarding a music-related interest of the user received from a source.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a functional block diagram that illustrates a system for creating a music taste profile.

FIG. 2 is a functional block diagram that illustrates a system for recommending music using a stored music taste profile.

FIG. 3 is a functional block diagram that illustrates a system for modifying a stored music taste profile.

FIG. 4 is a functional block diagram that illustrates a system for modifying a stored music taste profile.

FIG. 5 is a flow chart that illustrates a method of creating a music taste profile.

FIG. 6 is a flow chart that illustrates a method of creating a music taste profile.

FIG. 7 is a flow chart that illustrates a method of modifying a stored music taste profile.

FIG. 8 is a flow chart that illustrates a method of modifying a stored music taste profile.

FIG. 9 is a functional block diagram that illustrates an exemplary computing system.

### DETAILED DESCRIPTION

Various technologies pertaining to creating, using and/or dynamically modifying a music taste profile are now described with reference to the drawings, wherein like reference numerals are used to refer to like elements throughout. In the following description, for purposes of explanation, numerous specific details are set forth in order to provide a thorough understanding of one or more aspects. It may be evident, however, that such aspect(s) may be practiced without these specific details. In other instances, well-known structures and devices are shown in block diagram form in order to facilitate describing one or more aspects. Further, it is to be understood that functionality that is described as being carried out by certain system components may be performed by multiple components. Similarly, for instance, a component may be configured to perform functionality that is described as being carried out by multiple components.

The subject disclosure supports various products and processes that perform, or are configured to perform, various actions regarding creating, using and/or dynamically modifying a music taste profile. The music taste profile includes information about musical taste of a particular user that can be used to provide music recommendation(s) targeted to that particular user. What follows are one or more exemplary systems and methods.

Aspects of the subject disclosure pertain to the technical problem of creating, using and/or dynamically modifying a music taste profile. The technical features associated with addressing this problem involve dynamically modifying a stored music taste profile of a particular user based, for example, upon previous music listened to by the particular user through a particular application, passively obtained information about music listened to by the particular user (e.g., with the particular user's explicit consent—opt-in), obtained information about a web browsing search history of the particular user (e.g., with the particular user's explicit consent) and/or signal(s) provided by a digital assistant regarding information requested by the particular user (e.g., with the particular user's explicit consent). Music recommendation(s) are provided to the user based on the music taste profile. Accordingly, aspects of these technical features exhibit technical effects of more efficiently and effectively recommending music to the particular user, for example, increasing the particular user's satisfaction with music recommendations .

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

As used herein, the terms “component” and “system,” as well as various forms thereof (e.g., components, systems, sub-systems, etc.) are intended to refer to a computer-related entity, either hardware, a combination of hardware and software, software, or software in execution. For example, a component may be, but is not limited to being, a process running on a processor, a processor, an object, an instance, an executable, a thread of execution, a program, and/or a computer. By way of illustration, both an application running on a computer and the computer can be a component. One or more components may reside within a process and/or thread of execution and a component may be localized on one computer and/or distributed between two or more computers. Further, as used herein, the term “exemplary” is intended to mean serving as an illustration or example of something, and is not intended to indicate a preference.

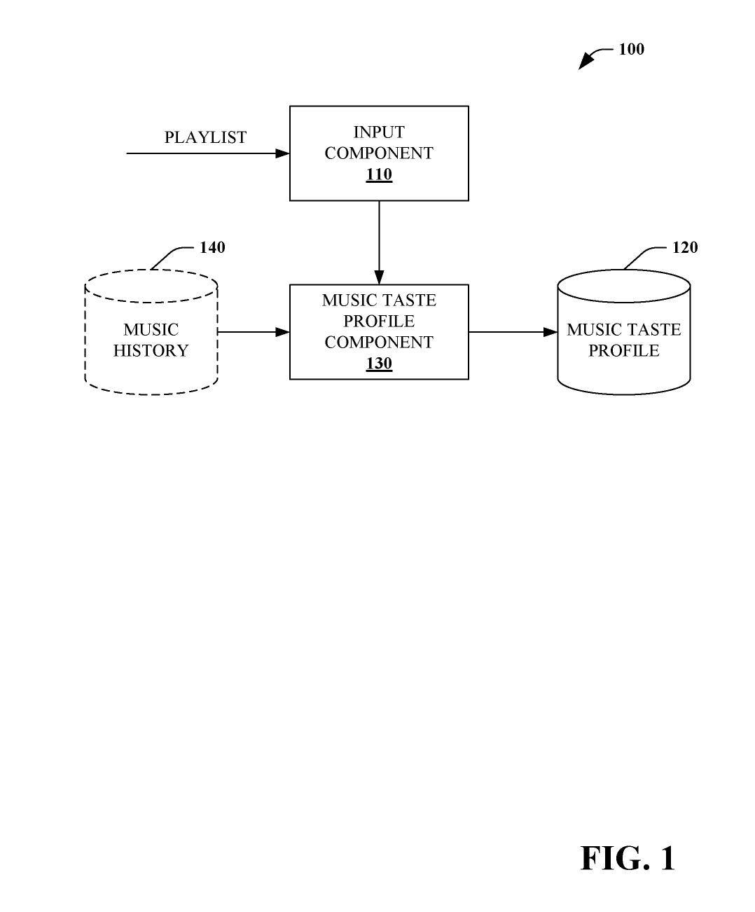

Referring to FIG. 1, a system for creating a music taste profile 100 is illustrated. The music taste profile includes information about musical taste of a particular user that can be used to provide music recommendation(s) targeted to that particular user. Thus, once created, the music taste profile 120 can be utilized to recommend song(s) to the particular user, as discussed in greater detail below. The system 100 includes an input component 110 to receive information from a user regarding a music taste profile 120. The system 100 further includes a music taste profile component 130 that creates the music taste profile 120 based upon information obtained from and/or about music taste of the user.

In one embodiment, the music taste profile 120 can initially be based upon a user's responses (e.g., obtained via a graphical user interface) to one or more questions regarding, for example, genre(s), artist(s) and/or song(s) that the user likes.

In one embodiment, the music taste profile 120 can be based upon usage of an associated music application (e.g., inferred based upon music the user listened to using the associated music application). For example, the system 100 can prepopulate a graphical user interface (e.g., grid) to first show things the system 100 has inferred the user already likes. Thus, if the system 100 infers that the user likes a particular artist, the system 100 can auto-like and/or suggest the use to like the particular artist because of previous signal(s). As the user selects item(s) in the graphical user interface (e.g., grid), as the user scrolls more the suggestions are more tailored to previous selections. So if the user selects “Pop” at the beginning, the user will see more pop artist(s) and sub-genre selection(s) scrolling down (e.g., using hierarchically organized graphical user interface(s)).

In one embodiment, the music taste profile component 130 can create the music taste profile 120 based upon information obtained from a music history store 140 (e.g., with explicit consent of the user). For example, the music taste profile component 130 can utilize an algorithm to mine information about songs (e.g., genre(s), artist(s) and/or song(s), etc.) the particular user has listened to, and/or a period of time the user has listened to each song from the music history store 140. In one embodiment, the music taste profile component 130 can hierarchically rank the mined information about songs when creating the music taste profile 120 such that higher ranked mined information is given greater significance when recommending songs over lower ranked mined information (e.g., based on frequency of listening and/or amount of each song listened to).

In one embodiment, the system 100 automatically creates and populates a playlist for the particular user based upon the created music taste profile 120. For example, the playlist can include a plurality of songs from each of the identified artist(s).

In one embodiment, the automatically created playlist can serve as an entry point for new user(s) to more fully experience dynamic music recommendations based, for example, upon the user's selection or non-selection of recommended music (e.g., playlist(s) and/or song(s)), resulting in modification in of the music taste profile 120, as discussed in greater detail below.

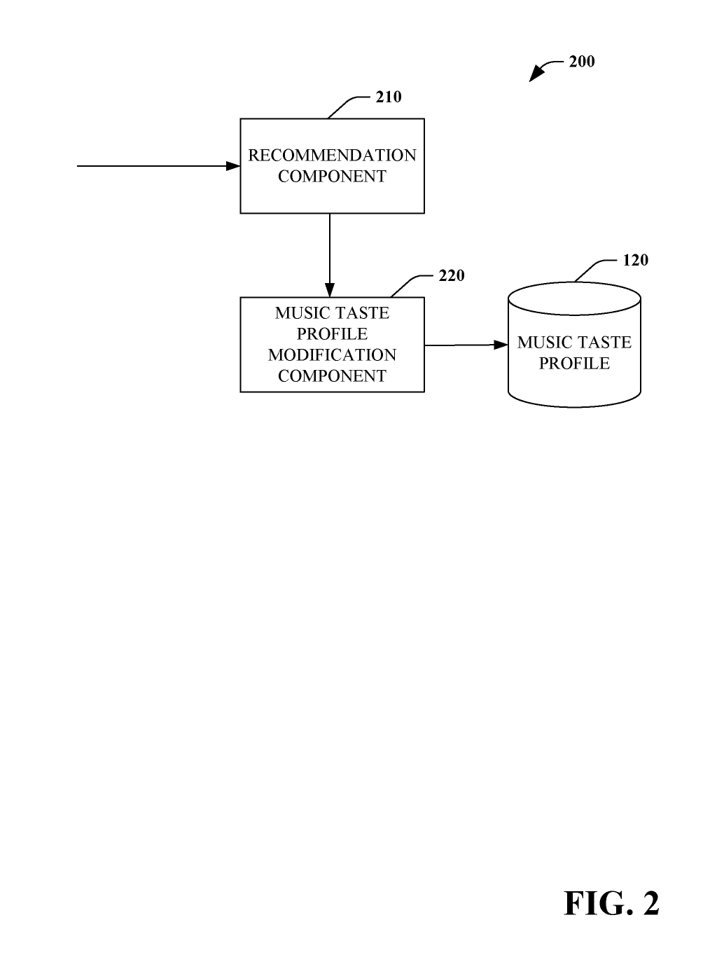

Turning to FIG. 2, a system for recommending music using a stored music taste profile 200 is illustrated. The system 200 utilizes the music taste profile 120 to make song recommendation(s) to a particular user. Optionally, the system 200 can modify the music taste profile 120 based upon song selection(s) of the particular user.

The system 200 includes a recommendation component 210 that utilizes the music taste profile 120 to make music recommendation(s) to the particular user. In one embodiment, the recommendation component 210 employs an algorithm to identifying (e.g., predict) music recommendations, for example, recommended song(s), new release(s) and/or playlist(s) based upon genre(s), artist(s) song(s) and/or metadata from previously listened to song(s) stored in the music taste profile 120. In one embodiment, if the music taste profile 120 identifies a particular genre of music, the recommendation component 210 can recommend song(s) and/or playlist(s) from that genre. In one embodiment, the music taste profile 120 identifies a particular artist, the recommendation component 210 can recommend song(s) and/or playlist(s) by that particular artist.

In one embodiment, the particular user can explicitly opt-in to obtaining music recommendation(s) based upon stored music taste profiles of other users (e.g., obtained and used with explicit consent of the other users and in a privacy-preserving manner). In one embodiment, the recommendation component 210 can employ a matching algorithm to identify recommended song(s) based upon song selection(s) of the other users (e.g., identified as having similar music taste profiles).

In one embodiment, the particular user can explicitly opt-in to obtaining song recommendation(s) from the recommendation component 210 using a social networking experience in which music taste profiles of one or more member(s) of the particular user's social network are used to identify recommended song(s) (e.g., obtained and used with explicit consent of the one or more member(s) of the particular user's social network and in a privacy-preserving manner).

In one embodiment, once presented with song recommendation(s), the user can utilize a graphical user interface element associated with a particular recommendation (e.g., hover) to initiate playing of a sample of a song (e.g., 30 second preview) associated with the particular recommendation.

In one embodiment, the music taste profile 120 can be dynamically modified by a music taste profile modification component 220 based on music to which the particular user listens. For example, if the particular user has recently listened to a particular genre, artist and/or song, the system 200 can infer that that the particular user is interested in that particular genre, artist and/or song and modify the music taste profile of the particular user accordingly.

In one embodiment, the user can modify the music taste profile 120 via the music taste profile modification component 220. For example, the user can select a graphical user interface (e.g., “user profile feedback”) to initiate modification. In response to the user input to modify the music taste profile 120, the user can be presented with one or more graphical user interface(s) (e.g., dashboard) presenting information about the user's current music taste profile 120. The user can then remove one or more item(s) of the music taste profile 120, for example, a particular genre, artist and/or song. The user can further be presented with one or more graphical user interface(s) to add a particular genre, artist and/or song to the music taste profile 120.

In one embodiment, a source of information in the music taste profile 120 is graphically identified to the user as being based on received explicit user input or inferred by the system 200.

In one embodiment, the music taste profile 120 can store temporal information, device information and/or location information. For example, the temporal information can identify music likes of the user during particular periods of time (e.g., morning, afternoon, evening, etc.) and/or when the user is performing certain activity(ies) (e.g., driving, walking, running, working out, etc.). The device information can identify music likes of the user when the user is listening to music from a particular device (e.g., mobile device, tablet, laptop, integrated car radio, etc.). The activity information can identify music likes of the user when the user is listening to music while performing a particular activity (e.g., in a particular room of a house, walking, running, driving, working out, etc.). In one embodiment, with knowledge of a current time, a current user device and/or a current activity of the user, the recommendation component 210 can utilize the music taste profile 120 to predict music recommendations for the user.

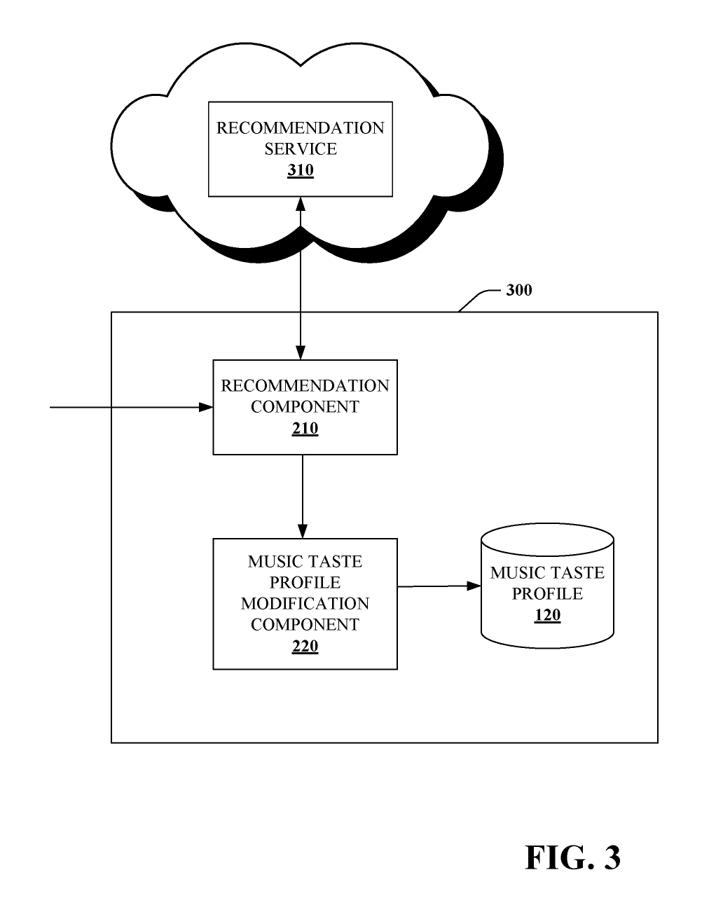

Next, referring to FIG. 3, a system for modifying a stored music taste profile 300 is illustrated. The system 300 includes a recommendation component 210, and a music taste profile component 220, as discussed above.

The system 300 further includes a remote recommendation service 310. The recommendation service 310 can be communicatively coupled to the recommendation component 210, for example, via the Internet. In one embodiment, the recommendation service 310 is cloud-based.

The recommendation service 310 can, in a privacy-preserving manner and with explicit consent of the particular user, receive information regarding the music taste profile 120 of the particular user. The recommendation service 130 can utilize the received information to provide song recommendations for the particular user to the recommendation component 210. The song recommendations can be based upon listening history of other users with similar music taste profile, obtained and used with explicit consent of the other users and in a privacy-preserving manner.

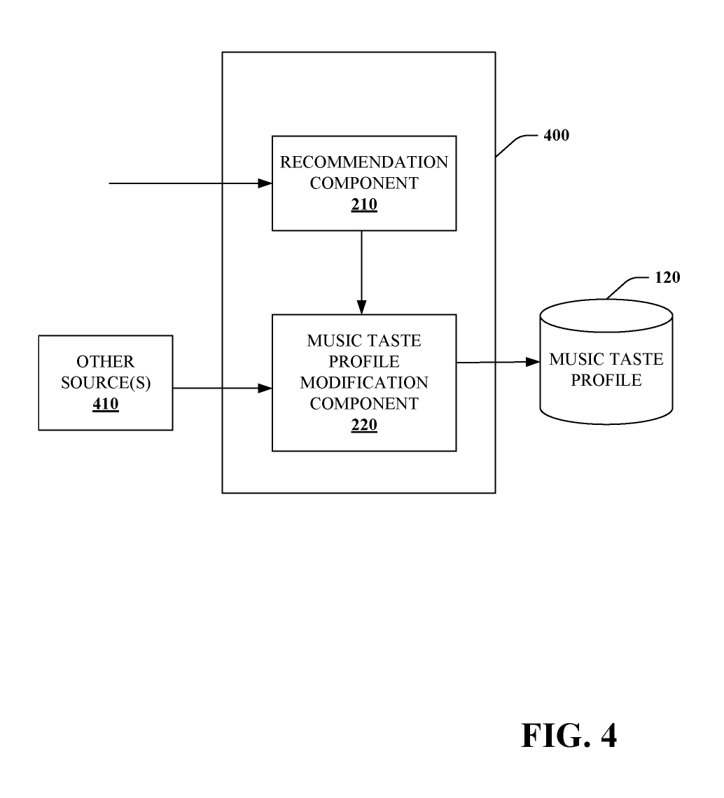

Turning to FIG. 4, a system for modifying a stored music taste profile 400 is illustrated. The system 400 includes a recommendation component 210, and a music taste profile component 220, as discussed above.

In one embodiment, the music taste profile modification component 220 can receive information about music interest(s) of the particular user from one or more other source(s) 410 (e.g., Internet browser, broadcast radio transmission (e.g., FM, AM, satellite, etc.), etc.). The particular user can opt-in to have the recommendation component 210 monitoring (in a privacy-preserving manner) music listening of the particular user from the one or more other source(s) 410. The music taste profile modification component 220 can modify the music taste profile of the user based upon the received information about music interest(s) of the particular user.

In one embodiment, the other source(s) 410 include device(s) playing music in proximity the user is present, for example, a CD player, a radio, a television, etc. With the user's explicit consent and in a privacy-preserving manner, a sensor (e.g., microphone) can provide a stream associated with the other source(s) to the music taste profile modification component 220 which can identify musical information associated with the stream (e.g., genre, artist, song, etc.). The music taste profile modification component 220 can utilize the identified musical information to modify the music taste profile 120.

In one embodiment, the other source(s) 410 includes a digital assistant (e.g., Cortana®). With the user's explicit consent and in a privacy-preserving manner, the digital assistant can provide information requested by the particular user (e.g., signals) regarding music. For example, the system 400 can infer from the digital assistant a user's routine, music a user likes on social media, music a user is listening to (e.g., in the car on the radio), music concert(s) the user is attending, music search(es) the user has asked about, movies the user likes, where the user lives (to suggest local songs), user demographics, etc.

Based upon the information provided by the digital assistant, the music taste profile modification component 220 can modify the music taste profile 120.

In one embodiment, the other source(s) 410 includes a browsing history of a web browser. With the user's explicit consent and in a privacy-preserving manner, the recommendation component 210 can review the browsing history, for example, for music-related search(es) (e.g., search for a particular artist, search for concert(s), search for song(s), etc.), music-related web page(s) visited (e.g., music video(s) watched). Based upon the review of the browsing history, the music taste profile modification component 220 can modify the music taste profile 120.

In one embodiment, the other source(s) 410 includes a home automation device. With the user's explicit consent and in a privacy-preserving manner, the home automation device can provide music-related information regarding the user. For example, by digitally scanning a location, the home automation device can provide information regarding image(s) (e.g., CD(s), movie poster(s), concert poster(s), musical group poster(s), etc.) displayed in proximity to the home automation device (e.g., in a user's home). For example, the home automation device can provide information requested by the particular user regarding music-related topic(s) (e.g., signals, commands, inquiries, etc.).

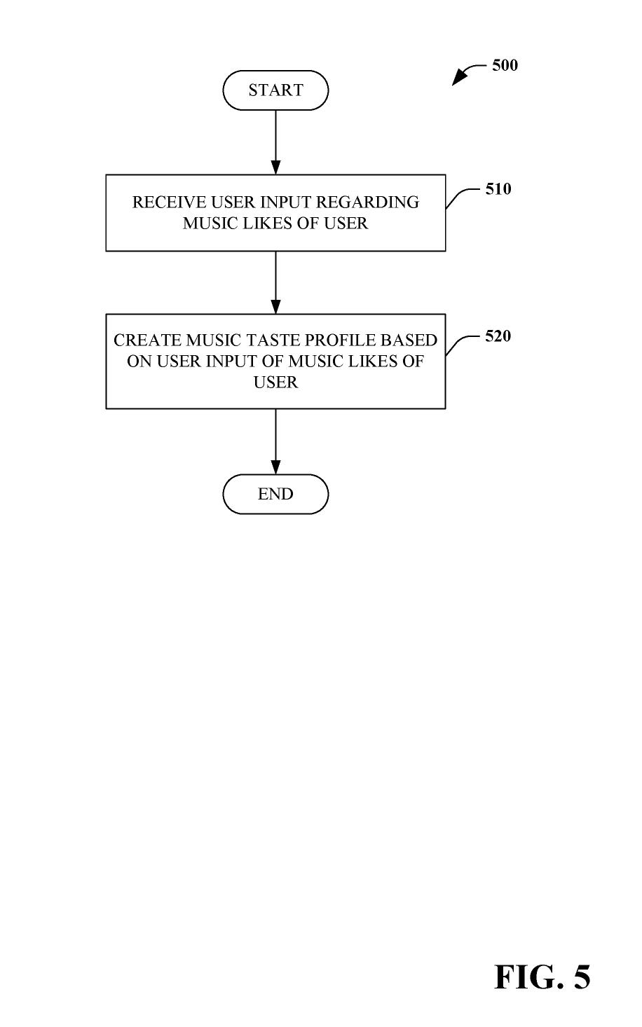

FIGS. 5-8 illustrate exemplary methodologies relating to creating, using and/or dynamically modifying a music taste profile. While the methodologies are shown and described as being a series of acts that are performed in a sequence, it is to be understood and appreciated that the methodologies are not limited by the order of the sequence. For example, some acts can occur in a different order than what is described herein. In addition, an act can occur concurrently with another act. Further, in some instances, not all acts may be required to implement a methodology described herein.

Moreover, the acts described herein may be computer-executable instructions that can be implemented by one or more processors and/or stored on a computer-readable medium or media. The computer-executable instructions can include a routine, a sub-routine, programs, a thread of execution, and/or the like. Still further, results of acts of the methodologies can be stored in a computer-readable medium, displayed on a display device, and/or the like.

Referring to FIG. 5, a method of creating a music taste profile 500 is illustrated. At 510, user input regarding music likes of the user. At 520, a music taste profile is created based upon the user input.

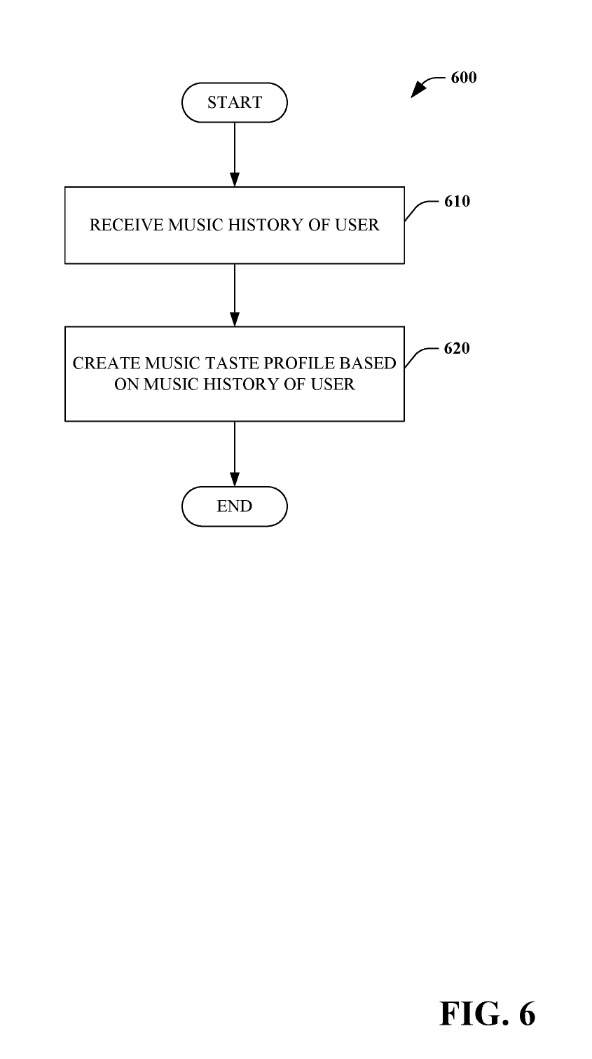

Turning to FIG. 6, a method of creating a music taste profile 600 is illustrated. At 610, a music history of a user is reviewed, with consent of the user. At 620, a music taste profile is created based upon the music history of the user.

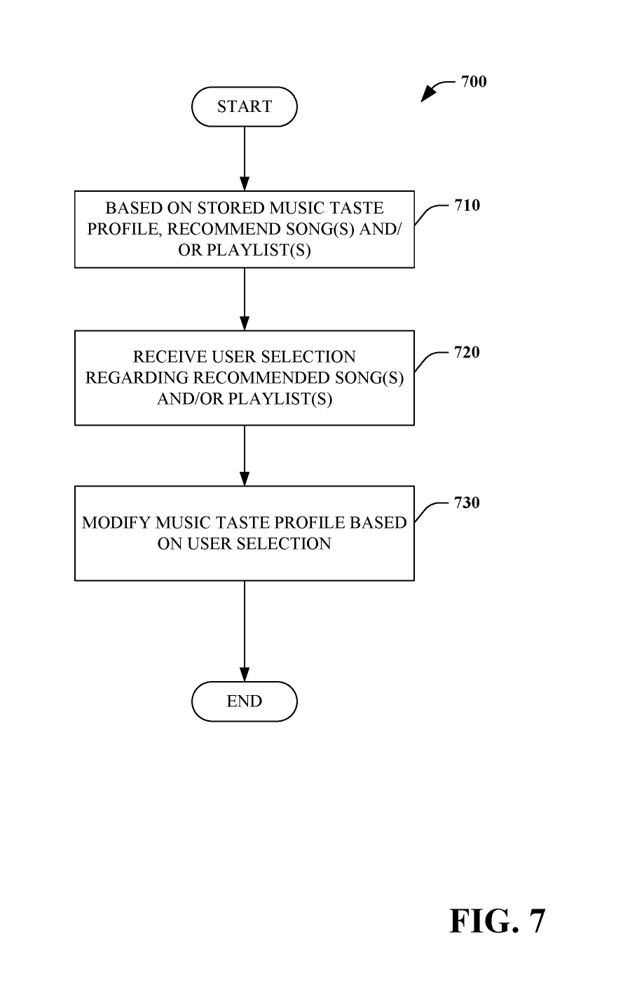

Next, referring to FIG. 7, a method of modifying a stored music taste profile 700 is illustrated. At 710, song(s) and/or playlist(s) are recommended to a user based upon a stored music taste profile. At 720, a selection regarding the song(s) and/or playlist(s) recommended to the user is received from the user. At 730, the music taste profiled is modified based on the user selection.

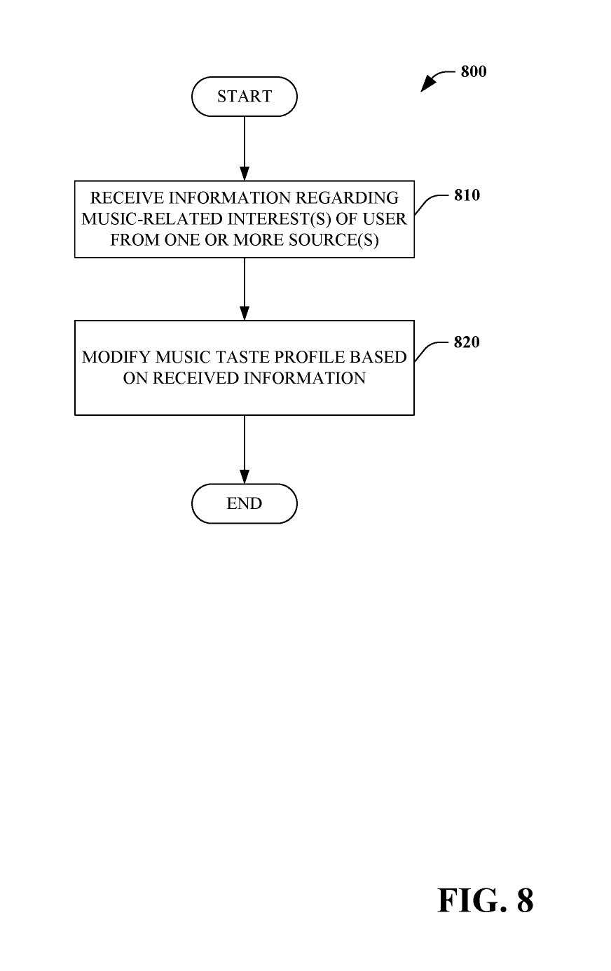

Turning to FIG. 8, a method of modifying a stored music taste profile 800 is illustrated. At 810, information regarding music-related interest(s) (e.g., activity(ies)) of a user is received from one or more source(s). At 820, a music taste profile associated with the user is modified based on the received information.

Described herein is a system for recommending music using a music taste profile. The system includes a computer comprising a processor and a memory. The memory includes a recommendation component configured to make a music recommendation to a user based on a music taste profile associated with the user, the recommendation component utilizing an algorithm to identify the music recommendation for the user. The memory further includes a music taste profile modification component configured to modify the music taste profile based on an inference from information regarding a music-related interest of the user received from a source.

The system can include wherein the recommendation component is further configured to make the music recommendation based upon a stored music taste profile of at least one other user. The system can further include wherein the recommendation component is further configured to make the music recommendation based upon a stored music taste profile of at least one other user, wherein the other user is a member of a particular social network in which the user is also a member. The system can include wherein the user can utilize a graphical user interface element associated with a particular recommendation of the music recommendation to initiate playing of a song associated with the particular recommendation.

The system can include wherein the music taste profile modification component is further configured to modify the music taste profile based user feedback. The system can further include wherein the user feedback is obtained via a graphical user interface presenting information about the music taste profile of the user. The system can include wherein the user can at least one of remove or add at least one of a genre, an artist or a song of the music taste profile using the graphical user interface.

The system can include wherein the recommendation component is further configured to provide the music taste profile of the user to a remote recommendation service, the remote recommendation service configured to provide music recommendations to the recommendation component based upon the music taste profile of the user and music taste profiles of a plurality of other users. The system can further include wherein the music taste profile is inferred based upon music the user listened to using a particular application. The system can include wherein the source comprises at least one of a browser, a broadcast radio transmission or a device playing music in proximity of the user.

The system can include a sensor configured to provide a stream associated with the source to the music taste profile modification, wherein the music taste profile modification is further configured to identify music information associated with the stream and to modify the music taste profile based upon the identified music information associated with the stream. The system can further include wherein the source comprises a digital assistant configured to execute on the computer, wherein the music taste profile recommendation component receives from the digital assistant information regarding at least one of music a user likes on social media, music a user is listening to, a music concert the user is attending, a music search the user has asked about, a movie the user likes, where the user lives or a user demographic. The system can include wherein the source comprises a home automation device, and, the music taste profile recommendation component receives from the home automation device information regarding an image displayed in proximity to the home automation device. The system can include wherein the source comprises a browsing history of the user.

Described herein is a method of modifying a stored music taste profile, comprising: receiving information regarding a music-related interest of a user from a source; and modifying the music taste profile based on the received information. The method can further include recommending a song to the user based upon the modified music taste profile.

Described herein is a computer storage media storing computer-readable instructions that when executed cause a computing device to: receive information regarding a music-related interest of a user from a source; and modify a music taste profile based on the received information. The computer storage media can include wherein the source comprises at least one of a browser, a broadcast radio transmission or a device playing music in proximity of the user. The computer storage media can store further computer-readable instructions that when executed cause the computing device to: receive a stream associated with the source; identify music information associated with the stream; and modify the music taste profile based upon the identified music information associated with the stream. The computer storage media can further include wherein the source comprises a digital assistant configured to execute on the computing device.

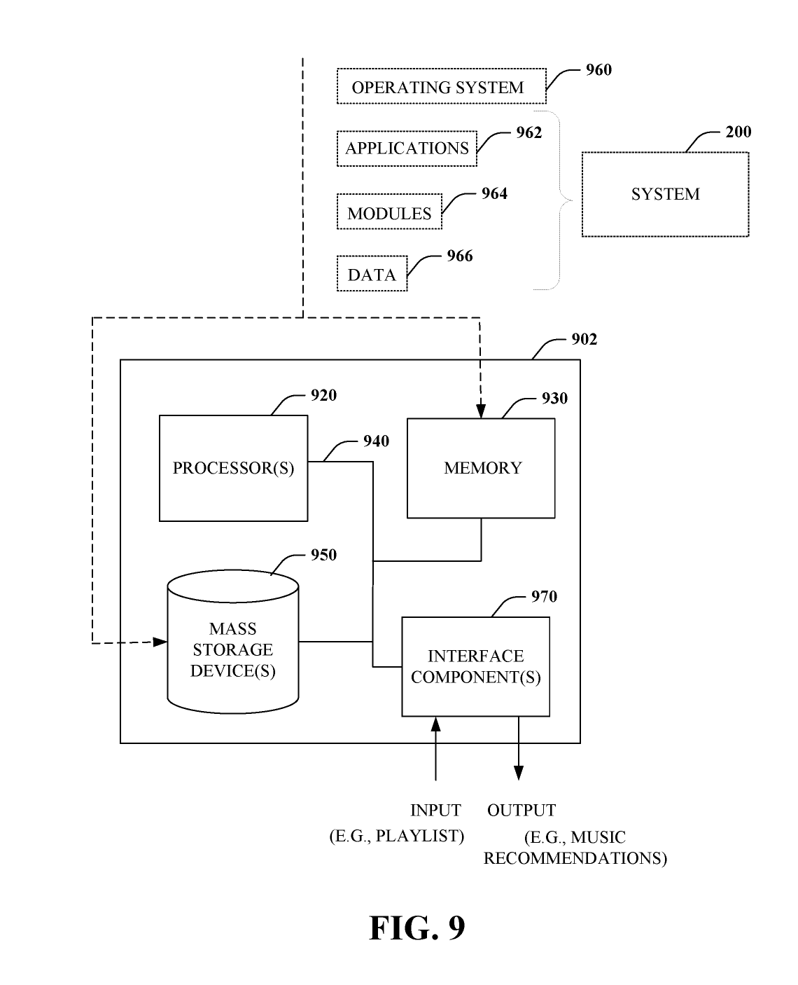

With reference to FIG. 9, illustrated is an example general-purpose computer or computing device 902 (e.g., mobile phone, desktop, laptop, tablet, watch, server, hand-held, programmable consumer or industrial electronics, set-top box, game system, compute node, etc.). For instance, the computing device 902 may be used in a system for using a music taste profile 200.

The computer 902 includes one or more processor(s) 920, memory 930, system bus 940, mass storage device(s) 950, and one or more interface components 970. The system bus 940 communicatively couples at least the above system constituents. However, it is to be appreciated that in its simplest form the computer 902 can include one or more processors 920 coupled to memory 930 that execute various computer executable actions, instructions, and or components stored in memory 930. The instructions may be, for instance, instructions for implementing functionality described as being carried out by one or more components discussed above or instructions for implementing one or more of the methods described above.

The processor(s) 920 can be implemented with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. The processor(s) 920 may also be implemented as a combination of computing devices, for example a combination of a DSP and a microprocessor, a plurality of microprocessors, multi-core processors, one or more microprocessors in conjunction with a DSP core, or any other such configuration. In one embodiment, the processor(s) 920 can be a graphics processor.

The computer 902 can include or otherwise interact with a variety of computer-readable media to facilitate control of the computer 902 to implement one or more aspects of the claimed subject matter. The computer-readable media can be any available media that can be accessed by the computer 902 and includes volatile and nonvolatile media, and removable and non-removable media. Computer-readable media can comprise two distinct and mutually exclusive types, namely computer storage media and communication media.

Computer storage media includes volatile and nonvolatile, removable and non-removable media implemented in any method or technology for storage of information such as computer-readable instructions, data structures, program modules, or other data. Computer storage media includes storage devices such as memory devices (e.g., random access memory (RAM), read-only memory (ROM), electrically erasable programmable read-only memory (EEPROM), etc.), magnetic storage devices (e.g., hard disk, floppy disk, cassettes, tape, etc.), optical disks (e.g., compact disk (CD), digital versatile disk (DVD), etc.), and solid state devices (e.g., solid state drive (SSD), flash memory drive (e.g., card, stick, key drive) etc.), or any other like mediums that store, as opposed to transmit or communicate, the desired information accessible by the computer 902. Accordingly, computer storage media excludes modulated data signals as well as that described with respect to communication media.

Communication media embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

Memory 930 and mass storage device(s) 950 are examples of computer-readable storage media. Depending on the exact configuration and type of computing device, memory 930 may be volatile (e.g., RAM), non-volatile (e.g., ROM, flash memory, etc.) or some combination of the two. By way of example, the basic input/output system (BIOS), including basic routines to transfer information between elements within the computer 902, such as during start-up, can be stored in nonvolatile memory, while volatile memory can act as external cache memory to facilitate processing by the processor(s) 920, among other things.

Mass storage device(s) 950 includes removable/non-removable, volatile/non-volatile computer storage media for storage of large amounts of data relative to the memory 930. For example, mass storage device(s) 950 includes, but is not limited to, one or more devices such as a magnetic or optical disk drive, floppy disk drive, flash memory, solid-state drive, or memory stick.

Memory 930 and mass storage device(s) 950 can include, or have stored therein, operating system 960, one or more applications 962, one or more program modules 964, and data 966. The operating system 960 acts to control and allocate resources of the computer 902. Applications 962 include one or both of system and application software and can exploit management of resources by the operating system 960 through program modules 964 and data 966 stored in memory 930 and/or mass storage device(s) 950 to perform one or more actions. Accordingly, applications 962 can turn a general-purpose computer 902 into a specialized machine in accordance with the logic provided thereby.

All or portions of the claimed subject matter can be implemented using standard programming and/or engineering techniques to produce software, firmware, hardware, or any combination thereof to control a computer to realize the disclosed functionality. By way of example and not limitation, system 100 or portions thereof, can be, or form part, of an application 962, and include one or more modules 964 and data 966 stored in memory and/or mass storage device(s) 950 whose functionality can be realized when executed by one or more processor(s) 920.

In accordance with one particular embodiment, the processor(s) 920 can correspond to a system on a chip (SOC) or like architecture including, or in other words integrating, both hardware and software on a single integrated circuit substrate. Here, the processor(s) 920 can include one or more processors as well as memory at least similar to processor(s) 920 and memory 930, among other things. Conventional processors include a minimal amount of hardware and software and rely extensively on external hardware and software. By contrast, an SOC implementation of processor is more powerful, as it embeds hardware and software therein that enable particular functionality with minimal or no reliance on external hardware and software. For example, the system 100 and/or associated functionality can be embedded within hardware in a SOC architecture.

The computer 902 also includes one or more interface components 970 that are communicatively coupled to the system bus 940 and facilitate interaction with the computer 902. By way of example, the interface component 970 can be a port (e.g., serial, parallel, PCMCIA, USB, FireWire, etc.) or an interface card (e.g., sound, video, etc.) or the like. In one example implementation, the interface component 970 can be embodied as a user input/output interface to enable a user to enter commands and information into the computer 902, for instance by way of one or more gestures or voice input, through one or more input devices (e.g., pointing device such as a mouse, trackball, stylus, touch pad, keyboard, microphone, joystick, game pad, satellite dish, scanner, camera, other computer, etc.). In another example implementation, the interface component 970 can be embodied as an output peripheral interface to supply output to displays (e.g., LCD, LED, plasma, etc.), speakers, printers, and/or other computers, among other things. Still further yet, the interface component 970 can be embodied as a network interface to enable communication with other computing devices (not shown), such as over a wired or wireless communications link.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications, and variations that fall within the spirit and scope of the appended claims. Furthermore, to the extent that the term “includes” is used in either the details description or the claims, such term is intended to be inclusive in a manner similar to the term “comprising” as “comprising” is interpreted when employed as a transitional word in a claim.

What is claimed is:

1. A system for recommending music using a music taste profile:
a computer comprising a processor and a memory, the memory comprising:
a recommendation component configured to make a music recommendation to a user based on a music taste profile associated with the user, the recommendation component utilizing an algorithm to identify the music recommendation for the user; and
a music taste profile modification component configured to modify the music taste profile based on an inference from information regarding a music-related interest of the user received from a source.

2. The system of claim 1, wherein the recommendation component is further configured to make the music recommendation based upon a stored music taste profile of at least one other user.

3. The system of claim 1, wherein the recommendation component is further configured to make the music recommendation based upon a stored music taste profile of at least one other user, wherein the other user is a member of a particular social network in which the user is also a member.

4. The system of claim 1, wherein the user can utilize a graphical user interface element associated with a particular recommendation of the music recommendation to initiate playing of a song associated with the particular recommendation.

5. The system of claim 1, wherein the music taste profile modification component is further configured to modify the music taste profile based user feedback.

6. The system of claim 5, wherein the user feedback is obtained via a graphical user interface presenting information about the music taste profile of the user.

7. The system of claim 6, wherein the user can at least one of remove or add at least one of a genre, an artist or a song of the music taste profile using the graphical user interface.

8. The system of claim 1, wherein the recommendation component is further configured to provide the music taste profile of the user to a remote recommendation service, the remote recommendation service configured to provide music recommendations to the recommendation component based upon the music taste profile of the user and music taste profiles of a plurality of other users.

9. The system of claim 1, wherein the music taste profile is inferred based upon music the user listened to using a particular application.

10. The system of claim 1, wherein the source comprises at least one of a browser, a broadcast radio transmission or a device playing music in proximity of the user.

11. The system of claim 1, further comprising a sensor configured to provide a stream associated with the source to the music taste profile modification, wherein the music taste profile modification is further configured to identify music information associated with the stream and to modify the music taste profile based upon the identified music information associated with the stream.

12. The system of claim 1, wherein the source comprises a digital assistant configured to execute on the computer, wherein the music taste profile modification component receives from the digital assistant information regarding at least one of music a user likes on social media, music a user is listening to, a music concert the user is attending, a music search the user has asked about, a movie the user likes, where the user lives or a user demographic.

13. The system of claim 1, wherein the source comprises a home automation device, and, the music taste profile recommendation component receives from the home automation device information regarding an image displayed in proximity to the home automation device.

14. The system of claim 1, wherein the source comprises a browsing history of the user.

15. A method of modifying a stored music taste profile, comprising:
receiving information regarding a music-related interest of a user from a source; and
modifying the music taste profile based on the received information.

16. The method of claim 15, further comprising:
recommending a song to the user based upon the modified music taste profile.

17. A computer storage media storing computer-readable instructions that when executed cause a computing device to:
receive information regarding a music-related interest of a user from a source; and
modify a music taste profile based on the received information.

18. The computer storage media of claim 17, wherein the source comprises at least one of a browser, a broadcast radio transmission or a device playing music in proximity of the user.

19. The computer storage media of claim 17, storing further computer-readable instructions that when executed cause the computing device to:
receive a stream associated with the source;
identify music information associated with the stream; and
modify the music taste profile based upon the identified music information associated with the stream.

20. The computer storage media of claim 17, wherein the source comprises a digital assistant configured to execute on the computing device.
